(19) United States
(12) Patent Application Publication
(10) Pub. No.: US 2006/0162165 A1
(43) Pub. Date: Jul. 27, 2006

(54) Long handle disposable razor

(76) Inventor: Faye Villalobos, Tucson, AZ (US)

Correspondence Address: Faye Villalobos, 443 E. McMillan, Tucson, AZ, 85705, US

(21) Appl. No.: 11/041,131

(22) Filed: Jan. 24, 2005

(51) Int. Cl. B26B 21/00

(52) U.S. Cl. 30/32

(57) ABSTRACT

Current and conventional disposable razors feature a short handle and do not enable a person who is physically challenged to reach certain parts of the body. Shaving legs is particularly difficult for persons with arthritis, disabilities, those suffering from obesity, or surgery patients to use the existing inventions. This invention provides a disposable razor with an extended handle and rotating shaving mechanism.

### TECHNICAL FIELD

The present invention relates generally to razors and is a disposable long handle razor that permits shaving of remote parts of the body.

### BACKGROUND

Existing inventions utilizing attachable extension arms for razors to allow for shaving of remote parts of the body are relatively common. However, they are limited to the types of razors to which they can be attached and do not necessarily have a rotating shaver head to allow for maximum range of use. Existing inventions utilize telescoping or extendable handles to be attached to razors or hair clippers. Consequently, there is a need to provide an appropriate disposable long handle razor for use by the above described individuals. The instant invention addresses this need.

The Canadian Institute for Health Information reports the majority of total knee (59.8%) and hip (57.8%) replacements were performed on women between 1994-1995 and 1999-2000. The total number is rising annually. These were for people aged 55 and older. Knee replacements increased by 33.2% and hip replacements by 8.5%.

The U.S. Dept. of Health and Human Services National Center for Health Statistics quotes the following figures for 2002:

| | |
|---|---|
| Total knee replacements: | 381,000 |
| Total hip replacements: | 193,000 females (average 2.3 per 1000) |

These and other individuals would benefit from the present invention.

The following patents describe previous attempts in the prior art to address the above problems:

U.S. Pat. No. 5,911,480, issued Jun. 15, 1999, to D. K. Morgan discloses a razor having an extendable, telescoping handle wherein the handle has at least one telescoping segment which is slidingly movable and frictionally securable to a number of extendable positions. Preferably, the handle is flexible and resilient to allow the razor blade to conform closely to the contours of the body portion being shaved. The telescoping handle is removable and can be secured to a variety of razors, such as disposable razors.

U.S. Pat. No. 6,266,888 B1, issued to D. K. Morgan discloses a reaching razor having a head portion, handle and an elongated, flexible neck having a head attachment end opposite a handle attachment end. The head portion is affixed to the head attachment end and the handle is attached to the handle attachment end such as to allow the user the ability to articulate the head attachment end in relation to the handle attachment end fully about the lateral center line of the handle.

U.S. Pat. No. 4,905,372, issued Mar. 6, 1990, to W. W. Willis, discloses a razor handle extension which is adapted to be detachably connected to the handle of a disposable razor to effectively increase the length of the handle and thereby permit a female user to more easily and safely shave her legs from an erect position. The razor handle extension has a gripping area at one end thereof. The opposite end includes a hollow receptacle for receiving and retaining the razor handle. A locking ring fits over the receptacle end of the razor handle extension for holding the razor handle within.

U.S. Pat. No. 5,600,887, issued February 1997, to B. Olson, discloses a flexible razor that includes a blade cartridge having a pair of opposing ends, an elongated handle, a flexible neck coupled to the handle, and a pair of mounting arms extending from the neck and securing the ends of the blade cartridge. In the preferred embodiment, the flexible neck can be protracted into and retracted from the handle by turning a rotatable cuff coupled to the handle. In another embodiment, the razor is provided with a flume attached to the flexible neck that is capable of converting a normal circular shaped water stream into a substantially rectangular-shaped stream and directing the substantially rectangular-shaped stream through the blade cartridge.

U.S. Pat. No. 5,167,069 issued Dec. 1, 1992, to K. H. Quinn, discloses a razor shaving apparatus having a telescopically extendable and retractable body with a manual handle at one end and a pivoting razor shaving assembly at its opposite end, and having a soap or lotion applicator detachably secured to the razor shaving assembly.

U.S. Pat. No. 6,052,905, issued Apr. 25, 2000, to Branchinelli, et al., discloses a razor for shaving and sculpting an area of hair on a user. The razor includes a first standard size razor head, a second narrow size razor head including a telescopic member extending therefrom and a handle including a top side integrally connected to the first standard size razor head. A first recess extends through the top side and into the handle forming a compartment. A second recess extends along a length of the handle and provides access to the compartment. The telescopic member is received by the compartment and is slideable therein. A slideable member is connected to the telescopic member and extends through the second recess for sliding the telescopic member within the compartment whereby movement of the slideable member moves the second narrow size razor head between a first extended position in which the telescopic member moves the second narrow size razor head between a first extended position in which the telescopic member extends substantially totally from the compartment and a second retracted position in which the telescopic member is substantially completely received within the compartment. Alternatively, the second narrow size razor head may also be integrally connected to the handle. Finally, the narrow size razor head may also be connected to an elongated handle by itself.

U.S. Pat. No. 4,129,942, issued Dec. 19, 1978 to N. H. Denizman, discloses a shaving implement defining a shaving head and a handle having an end portion carrying the shaving head for manipulation of the implement in a normal shaving razor manner. The handle further defines at least one chamber for holding dispensable shaving-associated or grooming material, such as shaving cream, aftershave lotion, pre-shave lotion, etc. Structure is provided for retaining the shaving-associated material removably within the handle or may be retained in a container removably received within the handle. A removable handle portion defined a second chamber for holding such shaving-related material may further serve as a closure for a chamber in a first portion of the handle arranged to receive a different shaving-associated material.

U.S. Pat. No. 3,233,324, issued Feb. 8, 1966, to J. van der Heide, discloses an electric hair clipper attachment for use with a rotary dry shaver having a drive shaft. The hair clipper comprises a housing having a slot at one end, means in the housing connected to the drive shaft for converting the rotary motion to reciprocating motion, and a set of relatively reciprocating blades projecting through the slot with clearance and operatively connected to the means. The housing and blade set are provided with corresponding studs and recesses. A spring in the housing normally urges the corresponding studs and recesses into engagement with each other with a depth of engagement substantially perpendicular to the plane of the blade set. The blade set is adapted to be displaced transversely to the longitudinal axis of the housing against the pressure of the spring to disengage the studs and corresponding recesses and permit the blade set to be removed forwardly through the slot.

The above cited prior art does not provide a suitable and stable means for shaving hair on remote areas. Consequently, there remains a need to provide an improved construction for a disposable long handle razor. Those of skill in the art will appreciate the present invention which addresses the above problems, as well as other problems.

U.S. Pat. No. 5,911,480, issued Jun. 15, 1999, to D. K. Morgan discloses a razor having an extendable, telescoping handle wherein the handle has at least one telescoping segment which is

### SUMMARY OF THE INVENTION

It is the objective of the present invention to provide an adequate and improved disposable shaving system and method for remote areas of the body.

It is also an object of the present invention to provide a flexible, long handle, disposable razor that permits the user to shave legs and other remote parts of the body that are difficult to reach because of disabilities or other physical limitations.

In view of these objectives, the present invention comprises a disposable razor with a flexible long handle and a rotating shaving head for shaving remote parts of the body when obesity, injury or disability limits the use of regular shaving systems.

### BRIEF DESCRIPTION OF THE DRAWINGS

FIG. 1 is an overhead view of the long handle disposable razor with a rotating razor head of the instant invention.

FIG. 2 is an elevational view, partially in section, of the side view of the razor and handle of the instant invention.

FIG. 3 is an elevational view, showing the razor and handle from the front end of the razor of the instant invention.

### DETAILED DESCRIPTION OF THE INVENTION

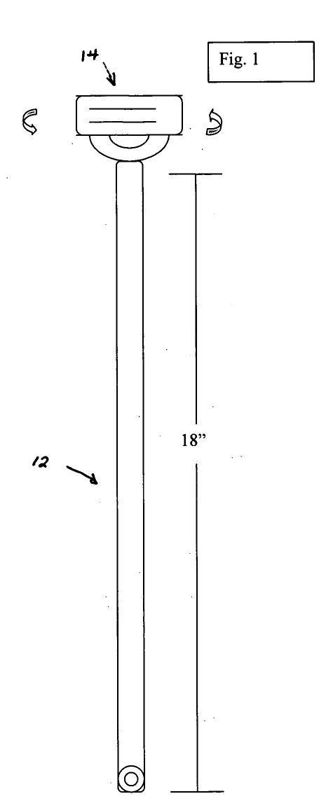

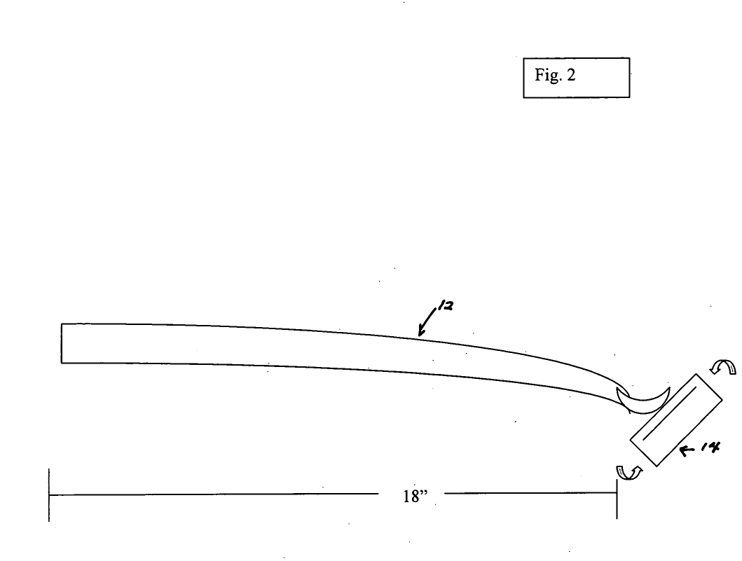

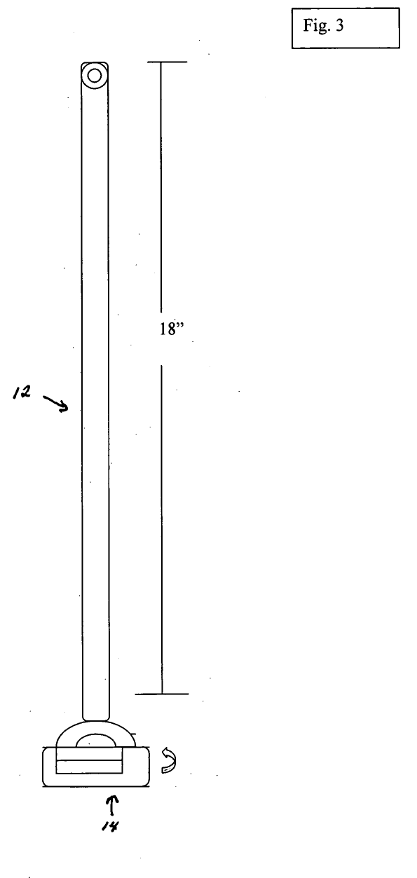

With reference to the drawings, FIGS. 1, 2 and 3 depict the instant invention which is referenced as a long handle disposable razor for shaving remote parts of the body.

With reference to FIG. 1, the razor system 10 comprises a long handle 12 and rotating shaving head 14. The razor head 14 is connected to the long handle 12. The razor head 14 has rotating capability. The long handle 12 is 12 inches in length and is constructed of flexible material. The log handle may be manufactured from colored or colorless or transparent plastic tubing. The razor head 14 is a swivel head to maximize use and to prevent nicks and cuts when shaving.

The cross section of the shaving system may be square, rectangular, oval or circular in design.

The long handle disposable razor may be made in colors for marketing purposes.

The instant invention is shown in the preferred embodiment. However, certain structural and/or functional modifications may occur to a person skilled in the art.

What is claimed:

1. A disposable shaving system designed for shaving remote parts of the body, including a rotating head razor with a long, flexible attached handle.

2. The system of claim 1, further comprising a rotating razor head connecting to the flexible extended handle and including a dual blade shaving mechanism.

3. The system of claim 1, wherein said long, flexible attached handle comprises at least one elastomeric portion.

4. A method for shaving remote portions of the body using the rotating razor comprising a long handle.
